(19) United States
(12) Patent Application Publication
(10) Pub. No.: US 2021/0065576 A1
(43) Pub. Date: Mar. 4, 2021

(54) SYSTEMS AND METHODS FOR GUIDED CREATION AND DEVELOPMENT OF SUPERVISED USER RESOURCE ACCOUNTS

(71) Applicant: BANK OF AMERICA CORPORATION, Charlotte, NC (US)

(72) Inventors: Christina Ann Lillie, Ann Arbor, MI (US); Charles Jason Burrell, Middleburg, FL (US); Sara Suzanne Carr, Fort Mill, SC (US); Jane Elizabeth Cook, Charlotte, NC (US); Justin Riley duPont, Charlotte, NC (US); Kajal Gupta, Charlotte, NC (US); Bradley Ryan Holland, Huntersville, NC (US); Robert Nyeland Huggins, Charlotte, NC (US); Kashif M. Siddiqui, Livingston, NJ (US)

(73) Assignee: BANK OF AMERICA CORPORATION, Charlotte, NC (US)

(21) Appl. No.: 17/000,624

(22) Filed: Aug. 24, 2020

Related U.S. Application Data
(60) Provisional application No. 62/894,082, filed on Aug. 30, 2019.

(51) Int. Cl. G09B 19/00; G06Q 40/02; G06Q 10/06; G06Q 40/06; G06Q 20/40; G06Q 30/02; G06Q 50/20; G06N 20/00; G06F 3/0484

(52) U.S. Cl. CPC G09B 19/00; G06Q 40/02; G06Q 10/063114; G06Q 40/06; G06Q 10/06316; G06Q 30/0631; G06Q 30/0215; G06Q 30/0203; G06Q 50/205; G06N 20/00; G06F 3/04842; G06Q 20/405

(57) ABSTRACT

The present disclosure embraces a system, methods and computer program products for the intelligent onboarding, support, education of supervised resource account users. The system, methods, and computer program products provide innovative tools for the development and management of supervised user resource accounts by a supervising user, and various embodiments providing unique pathways for resource management and education via the use of the disclosed resource management system.

### CROSS REFERENCE AND PRIORITY CLAIM UNDER 35 U.S.C. § 119

The present Application for a patent claims priority to U.S. Provisional Patent Application Ser. No. 62/894,082 entitled “NON-CONVENTIONAL RESOURCE DISTRIBUTION MANAGEMENT SYSTEM,” filed on Aug. 30, 2019 and assigned to the assignee hereof and hereby expressly incorporated by reference herein.

### FIELD

The present invention generally relates to systems and tools for the guided creation, management, and utilization of supervised resource accounts.

### BACKGROUND

There is a need for an efficient and intelligent way to educate and introduce non-conventional resource account users to management of resource accounts in order to provide increased access to resources and promote best practices for resource planning, investing, and spending.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The present disclosure is directed to a system for the intelligent onboarding, supervision, and support of non-conventional resource account users. In particular, the invention may provide an interactive and customizable interface and platform that is designed to gradually introduce new resource account users and provide existing resource account users with controls, educational tools, incentives, and rewards associated with supervised resource account users

Embodiments of the invention relate to systems, computer implemented methods, and computer program products for intelligent onboarding of non-conventional user resource accounts, generally comprising the steps of receive, from a user device, a request to access the resource account management platform; display to the user, via a graphical interface of the resource account management platform, a resource account summary and resource account management selections, wherein the resource account management selections comprise an option to onboard a second user; receive a selection to onboard the second user to the resource account management platform; and onboard the second user by automatically creating a resource account for the second user and linking the resource account for the second user with a resource account of the user by authorizing resource transfers from the resource account of the user and the resource account of the second user.

In some embodiments, the system further comprises generating a list of goals and tasks for display via the resource account management platform; displaying to the second user, via the graphical interface of the resource account management platform, the generated list of goals and tasks; receive an indication from the user device that the second user has completed one or more of the generated goals and tasks; automatically initiate a transfer of a predetermined resource amount from the resource account of the user to the resource account of the second user; and transmit an alert via the graphical user interface of the resource account management platform to the user.

In other embodiments, the alert further comprises recommendations for follow-up communication and discussion of resource management decisions and practices.

In further embodiments, the goals or tasks are created by the user via the resource account management platform and displayed to the second user automatically, and wherein the goals or tasks comprise a qualitative summary of necessary conditions for completion and quantitative resource amount associated with completion.

In still other embodiments, the system further comprises continuously monitoring a resource balance of the second user's resource account; receiving an indication via the resource account management platform that the second user has identified a goal product or service; retrieve a resource amount for the goal product or service from an external information source; identify one or more goals or tasks and associated resource reward amounts; and transmit a summary comparison of the resource amount for the goal product and the associated resource reward amounts of the one or more goals or tasks via the graphical user interface of the resource account management platform.

In other embodiments, the summary comparison is continuously updated based on the second user's completion of the one or more goals or tasks.

In still further embodiments, onboarding the second user further comprises: transmitting a series of questions to the user via the graphical user interface of the resource account management platform, and wherein subsequent questions may be dynamically altered based on the user's answer to previous questions; providing, via the graphical user interface of the resource account management platform, one or more recommendations for restrictions of the resource account of the second user; receiving a selection of one or more restrictions of the resource account of the second user; and automatically implementing the selected restrictions for the resource account of the second user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for the resource distribution account management platform, in accordance with one embodiment of the present disclosure;

FIG. 2 provides a block diagram illustrating a user device system, in accordance with an embodiment of the invention;

FIG. 3 illustrates a process flow for a goal-oriented resource reward process, in accordance with one embodiment of the present disclosure;

FIG. 4 illustrates a process flow for price comparison of goal products, in accordance with one embodiment of the present disclosure; and

FIG. 5 illustrates a process flow for guided creation of a supervised user resource account, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” as used herein may refer to an individual or an organization that owns and/or operates an online system of networked computing devices, systems, and/or peripheral devices on which the system described herein is implemented. The entity may be a business organization, a non-profit organization, a government organization, and the like, which may routinely use various types of applications within its enterprise environment to accomplish its organizational objectives.

“Entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

“Computing system” or “computing device” as used herein may refer to a networked computing device within the entity system. The computing system may include a processor, a non-transitory storage medium, a communications device, and a display. The computing system may be configured to support user logins and inputs from any combination of similar or disparate devices. Accordingly, the computing system may be a portable electronic device such as a smartphone, tablet, single board computer, smart device, or laptop. In other embodiments, the computing system may be a stationary unit such as a personal desktop computer, networked terminal, IoT device, or the like.

“User” as used herein may refer to an individual who may interact with the entity system to access the functions therein. Accordingly, the user may be an agent, employee, associate, contractor, or other authorized party who may access, use, administrate, maintain, and/or manage the computing systems within the entity system. In other embodiments, the user may be a client or customer of the entity.

Accordingly, as used herein the term “user device” or “mobile device” may refer to mobile phones, personal computing devices, tablet computers, wearable devices, desktop computers, laptop computers, IoT devices, smart devices (e.g., smart watches), and/or other types of computing systems or devices and/or any electronic device capable of receiving and/or storing data therein.

“Resource” as used herein may refer to an object under the ownership of a user which is stored or maintained by the entity on the user's behalf. The resource may be intangible or tangible objects such as data files, documents, biographical data, funds, and the like. Typically, the user's account contains records of the resources owned by the user. Account data may be stored in an account database within the entity's systems.

Embodiments of the present disclosure provide a solution for on-boarding and continued support of non-conventional, or “supervised,” resource account users that own and maintain a resource account with an entity, or that may be authorized as an additional user on an existing user resource account stored with the entity. As used herein, the term “non-conventional” user refers to a certain user that may not previously have established a resource account, but may still benefit from limited interaction, gradually increased interaction, or supervised interaction with resource accounts. For instance, a non-conventional user may be a user who is below a certain experience level, has had less than a threshold amount of birthdays, or the like, whom is interested in learning effective methods of resource management and accounting principles, but does not yet have the ability to establish a credit history or independent resource account of their own. In other instances, the non-conventional user may be a user that has had a requisite number of birthdays to be considered a legal adult and can legally establish an independent account, but may still benefit from educational guidance with respect to responsible and effective management of resources, budgeting of resources, investing of resources or the like. It is understood that the terms non-conventional user and supervised user may be used interchangeably herein.

Additionally, the non-conventional user may, in some instances, benefit from the simulated or gradual introduction to channels of resource transfer, such as resource transaction channels (e.g. use of credit cards, checks, or the like), deposit channels (e.g. establishment of a savings account, accrual of interest, or the like), and withdrawal channels (e.g. use of an automated teller machine, or “ATM,” interaction with an entity agent or teller at an entity location, or the like). In some instances, the entity may build a relationship with the non-conventional user over time, and may establish a rapport or account history with the non-conventional user such that the entity may deem the non-conventional user as a low hazard candidate for a resource account by the time they reach the appropriate or requisite legal number of birthdays to establish an individual resource account or credit line of their own.

As such, the solution provides systems that are designed to both encourage and educate supervised users regarding resource management in a number of ways. Additionally, the solution described herein is designed to provide tools for users to manage, interact, and supervise non-conventional users, offering users, such as parents of supervised users, the ability to set preferences and easily access, protect, and manage information regarding one or more supervised users' activity and interaction with resource accounts, as well as their management and access to resources stored in such accounts.

In some embodiments, educational content may be provided through the use of simulated resource management exercises, establishment of goals and milestones, the provision of specialized resource channels for supervised users, and the like. In the same or similar embodiments, incentives may be provided in the form of goals and associated rewards, gamification of resource management practices, guaranteed earning of additional resources based on completed milestones, establishment of rewards with partnering entities related to supervised user interests, simplified or tailored user interface platforms provided on user devices, and the like. The system may further provide for automated execution of certain processes based set user preferences, and may provide proactive alerts, recommendations, and feedback based on activity of supervising users and supervised users as they interact with resource accounts.

An exemplary use case of the system described herein follows. The system may be owned and/or operated by an entity such as a financial institution, where the resource account management platform aggregates data regarding an account of a user (e.g., a client of the financial institution). For example, the aggregated data may include account settings, user preferences, account resources (e.g., an account balance), history of interactions between the user and entity (e.g., account logins, software installed, locations of the entity visited by the user, or the like), products or services currently in use and/or offered by the entity, or the like. In such an embodiment, the system may comprise an account interface tool, where the account interface tool provides, via a graphical interface, one or more indicators (e.g., status meter, gauge, chart, graph, or the like) of various features the client may use that are offered by their resource account with the entity. For instance, the account interface tool may notify the user about which features are being used or not being used. If the system detects that a particular feature is not being used, the graphical interface may further provide an interactive link (e.g., clickable button, hyperlink, or the like) which may direct the client to a set-up page for the non-activated feature (e.g., savings goal-setting, controlled resource spending tools, educational games, access to credit lines, access to investment strategy recommendations and education, and the like). In this way, the system may allow the users to efficiently navigate the various features offered by the entity for account optimization purposes.

In some embodiments, the graphical interface may be configured to present to the user a guided setup page (e.g., a landing zone) which may present to the user a process flow for optimizing the user's account or for onboarding a supervised user. For instance, the graphical interface may display various items to the user, such as an itemized list of steps that the user may take to enroll in the products and/or services offered by the entity, new products or features, or the like. In some embodiments, the graphical interface may further display legacy products or services provided by the entity which may still be in use by the client. The system may further display a comparison of the benefits and/or features of legacy products in comparison with newer products such that the client may at a glance determine which product is optimal.

In some embodiments, the system may be configured to integrate features and/or functions across multiple communication channels. In this regard, the system may automatically push information about certain features and/or the signup of said features or functions to the user device (e.g., a first communication channel) based on an interaction with the user across a second communication channel or device. In an exemplary embodiment, the entity may have had a telephone conversation with a client about a savings oriented educational feature of the entity geared toward helping young supervised users with understanding the management of resources. Based on the telephone conversation, the system may automatically push a signup page or process of onboarding the savings oriented educational feature to the user via a user device (e.g., mobile phone).

In other embodiments, a decision engine and/or artificial intelligence (“AI”) system may automatically prioritize which features to highlight to the user based on their account information or information known about the user. In certain embodiments, the decisioning of the AI system may be overridden via an associate interaction. For instance, if the AI system has decided to prioritize informing the user about savings incentives for supervised users, but an agent (e.g., an employee of the entity) has determined that the user is not interested in that particular product (e.g., via a phone conversation with the client), the agent may override the notification regarding certain features with respect to said user. The system may further use machine learning to determine prioritizations on a per-user basis. For instance, the system may determine, via machine learning, that a particular user responds well to a particular prioritization, where a supervised user may respond well to a second prioritization.

The system may further be configured to recognize behaviors or patterns of the user (e.g., via machine learning). For instance, the system may detect that the user is having issues with a payment card (e.g., the user is repeatedly attempting to insert the card into a payment terminal or ATM). Based on detecting the user behavior and/or the underlying issue, the system may automatically push a notification to the user regarding the underlying issue (e.g., the security chip on the credit card has failed). In such an embodiment, the notification may recommend a solution to the underlying issue (e.g., recommend that the user replace the credit card). In other embodiments, the system may further track user's purchasing and/or payment behaviors, or track the behaviors of supervised users that are authorized to access the user's account or may be authorized on a case-by-case basis or in some limited manner to access resources from the user's account (e.g. the user may set preferences to authorize a child to use a debit card attached to the user's resource account in order to make certain types of purchases in a certain location, for specific types of goods or services, or during a specific time frame). Based on the user's behaviors and set preferences, the system may notify the user of activity on their account that has been authorized or denied based on the user's set preferences and behaviors. In some embodiments, the system may further learn the timing of behaviors of the user. For instance, if the system detects that the user typically accesses the entity system in the evening, the system may time pushing certain notifications to the user to coincide with the times in which the user is generally active in the entity system.

In some embodiments, the system may provide information to the user or supervised user via a mobile device, web browser, wearable device, IoT device, or the like in order to provide resource account summary information or to assist in the creation of goals and enrollment in certain motivations. For instance, the supervised user may enroll in an earning and savings program in which the resource account management tool is programmed by the user to record the supervised user's daily, weekly, or monthly allowance. In some embodiments, the resource account management tool may identify certain products, motivations and goals that the supervised user may feasibly achieve and work towards by allocating and saving resources over a period of time. For instance, the system may identify, based on the supervised user's number of birthdays, that they may be interested in a number of products that other others of that same number of birthdays are interested in, or that coincide with a portion of the supervised user's weekly allowance if the portion of the weekly allowance is saved for a given period of time, such as a month.

In some embodiments, the relationship of the supervising user and the supervised user may not be familial, but instead job or employment based. For instance, the supervising user may be a business manager who maintains and manages one or more accounts for supervised users (employees, staff members, or the like). In some embodiments, the goals or tasks shown in the resource account management tool may be related to job or employment milestones, tasks, assignments or the like which the supervised user may choose to complete in order to receive a motivation or reward, in the form of resources or the like.

In some embodiments, the system may interact with the supervised user, by displaying a graphical depiction of the products, price of the products, transmit an audio message and the like, and may partner such information with additional helpful contextual information such as current savings, savings goal, estimated period of time to reach the goal, and the like. For instance, the system may display the information on a smart home device that contains a graphical user interface in response to an audio request from the supervised user to retrieve such information. In some embodiments, the system may accompany the graphical depiction of the information with an audio response. The requested information may also include additional recommendations and links to directly purchase recommended products, services, or redeem rewards. Depending on the account authorization preferences associated with the resource account as set by the user, the purchasing of products may be executed directly, or in other embodiments may require further authorization from the user or user's parent. In some instances, the system may be programmed to forward the goal to the user or parent via a separate channel of communication, such as directly to the user's mobile device, wearable or the like, so that the user may be informed about the supervised user's goals, interests, and desired future purchases.

The system may also support user authentication via alternative credentials. For instance, rather than authenticating a user via a username and password (e.g., as used in online transactions), the system may support authentication of a user via a card associated with the user (e.g., a debit card of the user). In some embodiments, the system may further integrate various features, products, and/or services of partnered entities and/or affiliate entities.

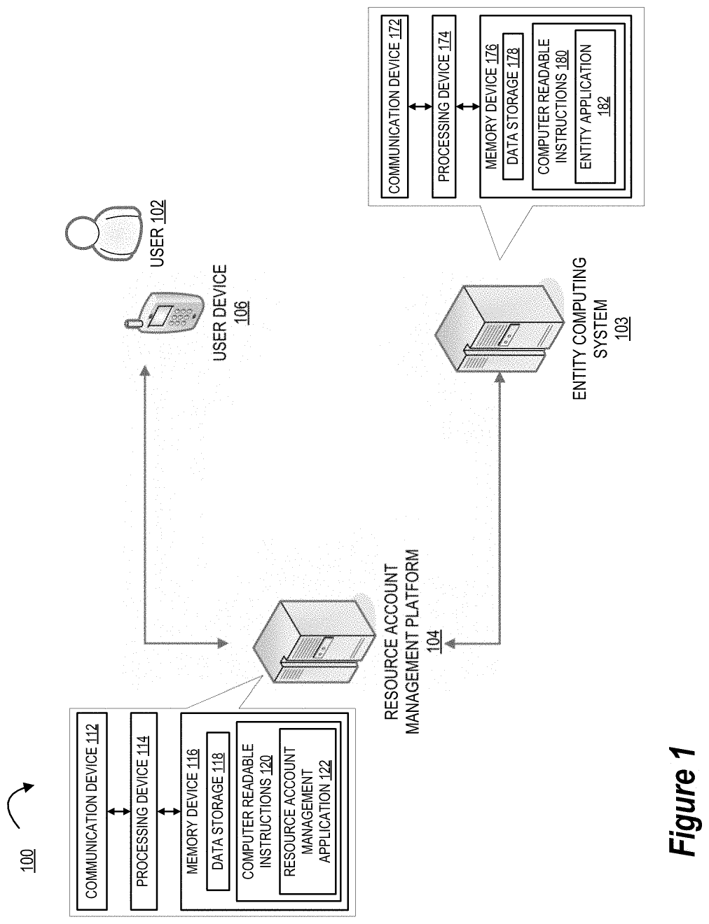

Turning now to the figures, FIG. 1 illustrates an operating environment for the supervised resource distribution account management platform, in accordance with one embodiment of the present disclosure. In particular, FIG. 1 illustrates a resource account management platform 104 that is operatively coupled, via a network, to a user device 106 and/or an entity computing system 103. In such a configuration, the resource account management platform 104 may transmit information to and receive information from the user device 106 and/or the entity computing system 103. It should be understood that FIG. 1 illustrates only an exemplary embodiment of the operating environment 100, and it will be appreciated that one or more functions of the systems, devices, or servers as depicted in FIG. 1 may be combined into a single system, device, or server. For instance, the functions of the resource account management platform 104 and the entity computing system 103 may be executed on a single computing system. Furthermore, a single system, device, or server as depicted in FIG. 1 may represent multiple systems, devices, or servers.

The network may be a system specific distributive network receiving and distributing specific network feeds and identifying specific network associated triggers. The network include one or more cellular radio towers, antennae, cell sites, base stations, telephone networks, cloud networks, radio access networks (RAN), WiFi networks, or the like. Additionally, the network may also include a global area network (GAN), such as the Internet, a wide area network (WAN), a local area network (LAN), or any other type of network or combination of networks. Accordingly, the network may provide for wireline, wireless, or a combination wireline and wireless communication between devices on the network.

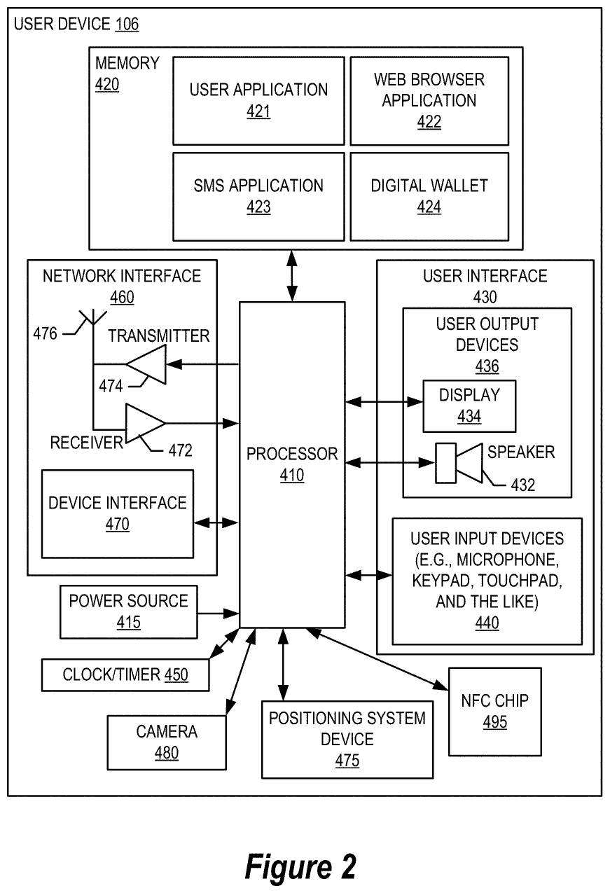

The user device 106 as depicted in FIG. 1, and as further described in FIG. 2, may be a device which is owned and/or operated by a user 102. The user 102 may use the user device 106 to log onto the resource account management platform 104 and/or the entity computing system 103 to access the data aggregation functions as described herein. In this regard, the user device 106 may be a mobile device such as a smartphone, wearable smart device, tablet, laptop computer, or the like. In other embodiments, the user device 106 may be a stationary device such as a desktop computer, IoT device, networked terminal, or the like.

As further illustrated in FIG. 1, the resource account management platform 104 may be a computing system within the entity system which provides data aggregation and integration functions across multiple channels. Accordingly, the resource account management platform 104 may comprise a communication device 112, a processing device 114, and a memory device 116, where the processing device 114 is operatively coupled to the communication device 112 and the memory device 116. The processing device 114 uses the communication device 112 to communicate with the network and other devices on the network, such as, but not limited to the user device 106 and/or the entity computing system 103. As such, the communication device 112 generally comprises a modem, antennae, WiFi or Ethernet adapter, radio transceiver, or other device for communicating with other devices on the network.

The memory device 116 comprises computer-readable instructions 120 and data storage 118, which in one embodiment includes the computer-readable instructions 120 of a resource account management application 122. The resource account management application 122 may comprise executable code for causing the processing device 114 to perform various data aggregation and integration functions with respect to data associated with the user 102. In this regard, the resource account management platform 104 may receive authentication credentials from the user 102, the user device 106, and/or the entity computing system 103 and authenticate/authorize users and applications based on the authentication credentials. Examples of said authentication credentials may include a username and password combination, PIN, secure token, cryptographic key, biometric data, or the like.

The operating environment 100 may further comprise an entity computing system 103. The entity computing system 103 may refer to a computing system which may be operated by a user such as an administrator or employee of the entity. The entity computing system 103 may comprise a processing device 174 operatively coupled to the communication device 172 and a memory device 176 comprising data storage 178 and computer readable instructions 180. The computer readable instructions 180 may comprise an entity application 182 which may be configured to instruct the processing device 174 to execute certain functions over the network, such as interacting with the user device 106 and/or the resource account management platform 104.

The communication device 172, and other communication devices as described herein, may comprise a wireless local area network (WLAN) such as WiFi based on the Institute of Electrical and Electronics Engineers' (IEEE) 802.11 standards, Bluetooth short-wavelength UHF radio waves in the ISM band from 2.4 to 2.485 GHz or other wireless access technology. Alternatively or in addition to the wireless interface, the entity computing system 103 may also include a communication interface device that may be connected by a hardwire connection to the resource distribution device.

The computing systems described herein may each further include a processing device communicably coupled to devices as a memory device, output devices, input devices, a network interface, a power source, a clock or other timer, a camera, a positioning system device, a gyroscopic device, one or more chips, and the like.

In some embodiments, the computing systems may access one or more databases or datastores (not shown) to search for and/or retrieve information related to the service provided by the entity. The computing systems may also access a memory and/or datastore local to the various computing systems within the operating environment 100.

The processing devices as described herein may include functionality to operate one or more software programs or applications, which may be stored in the memory device. For example, a processing device may be capable of operating a connectivity program, such as a web browser application. In this way, the computing systems may transmit and receive web content, such as, for example, product valuation, service agreements, location-based content, and/or other web page content, according to a Wireless Application Protocol (WAP), Hypertext Transfer Protocol (HTTP), and/or the like.

A processing device may also be capable of operating applications. The applications may be downloaded from a server and stored in the memory device of the computing systems. Alternatively, the applications may be pre-installed and stored in a memory in a chip.

The chip may include the necessary circuitry to provide integration within the devices depicted herein. Generally, the chip will include data storage which may include data associated with the service that the computing systems may be communicably associated therewith. The chip and/or data storage may be an integrated circuit, a microprocessor, a system-on-a-chip, a microcontroller, or the like. In this way, the chip may include data storage. Of note, it will be apparent to those skilled in the art that the chip functionality may be incorporated within other elements in the devices. For instance, the functionality of the chip may be incorporated within the memory device and/or the processing device. In a particular embodiment, the functionality of the chip is incorporated in an element within the devices. Still further, the chip functionality may be included in a removable storage device such as an SD card or the like.

A processing device may be configured to use the network interface to communicate with one or more other devices on a network. In this regard, the network interface may include an antenna operatively coupled to a transmitter and a receiver (together a “transceiver”). The processing device may be configured to provide signals to and receive signals from the transmitter and receiver, respectively. The signals may include signaling information in accordance with the air interface standard of the applicable cellular system of the wireless telephone network that may be part of the network. In this regard, the computing systems may be configured to operate with one or more air interface standards, communication protocols, modulation types, and access types. By way of illustration, the devices may be configured to operate in accordance with any of a number of first, second, third, fourth, and/or fifth-generation communication protocols and/or the like. For example, the computing systems may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with fifth-generation (5G) wireless communication protocols, or the like. The devices may also be configured to operate in accordance with non-cellular communication mechanisms, such as via a wireless local area network (WLAN) or other communication/data networks.

The network interface may also include an application interface in order to allow a user or service provider to execute some or all of the above-described processes. The application interface may have access to the hardware, e.g., the transceiver, and software previously described with respect to the network interface. Furthermore, the application interface may have the ability to connect to and communicate with an external data storage on a separate system within the network.

The devices, platforms, and computing systems depicted in FIG. 1 may have an interface that includes user output devices and/or input devices. The output devices may include a display (e.g., a liquid crystal display (LCD) or the like) and a speaker or other audio device, which are operatively coupled to the processing device. The input devices, which may allow the devices to receive data from a user 102, may include any of a number of devices allowing the devices to receive data from a user 102, such as a keypad, keyboard, touch-screen, touchpad, microphone, mouse, joystick, other pointer device, button, soft key, and/or other input device(s).

The devices, platforms, and computing systems may further include a power source. Generally, the power source is a device that supplies electrical energy to an electrical load. In some embodiment, power source may convert a form of energy such as solar energy, chemical energy, mechanical energy, or the like to electrical energy. Generally, the power source may be a battery, such as a lithium battery, a nickel-metal hydride battery, or the like, that is used for powering various circuits, e.g., the transceiver circuit, and other devices that are used to operate the devices. Alternatively, the power source may be a power adapter that can connect a power supply from a power outlet to the devices. In such embodiments, a power adapter may be classified as a power source “in” the devices.

As described above, the devices, platforms, and computing systems as shown in FIG. 1 may also include a memory device operatively coupled to the processing device. As used herein, “memory” may include any computer readable medium configured to store data, code, or other information. The memory device may include volatile memory, such as volatile Random Access Memory (RAM) including a cache area for the temporary storage of data. The memory device may also include non-volatile memory, which can be embedded and/or may be removable. The non-volatile memory may additionally or alternatively include an electrically erasable programmable read-only memory (EEPROM), flash memory or the like. The memory device may store any of a number of applications or programs which comprise computer-executable instructions/code executed by the processing device to implement the functions of the devices described herein. The computing systems may further comprise a gyroscopic device. The positioning system, input device, and the gyroscopic device may be used in correlation to identify phases within a service term.

Each computing system may also have a control system for controlling the physical operation of the device. The control system may comprise one or more sensors for detecting operating conditions of the various mechanical and electrical systems that comprise the computing systems or of the environment in which the computing systems are used. The sensors may communicate with the processing device to provide feedback to the operating systems of the device. The control system may also comprise metering devices for measuring performance characteristics of the computing systems. The control system may also comprise controllers such as programmable logic controllers (PLC), proportional integral derivative controllers (PID) or other machine controllers. The computing systems may also comprise various electrical, mechanical, hydraulic or other systems that perform various functions of the computing systems. These systems may comprise, for example, electrical circuits, motors, compressors, or any system that enables functioning of the computing systems.

FIG. 2 provides a block diagram illustrating the user device 106 of FIG. 1, in accordance with an embodiment of the invention. In one embodiment of the invention, the user device 106 is a mobile device. However, it should be understood that a mobile device or mobile telephone are merely illustrative of one type of user device 106 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned. In some embodiments, one or more of the functionalities or components of the user device 106 may be represented in whole or in part by one or more auxiliary devices 170.

Furthermore, it should be known that multiple computing device systems 400 may be owned by or accessed by the user 110 within the system environment 100 of FIG. 1, and these separate computing device systems 400 may be in network communication with each other and the other systems and devices of the system environment 100. For example, a first user device 106 may comprise a mobile phone of the user 110 that includes an NFC chip with resource data stored therein, and this mobile phone may be placed within an NFC interaction distance from an NFC reader device of a second user device 106 that comprises a personal computer of the user 110.

Some embodiments of the user device 106 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the user device 106. For example, the processor 410 may include a digital signal processor device, a microprocessor device, and various analog to digital converters, digital to analog converters, and/or other support circuits. Control and signal processing functions of the user device 106 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the user device 106 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of a wireless network. In this regard, the user device 106 may be configured to operate with one or more air interface standards, communication protocols, modulation types, and access types. By way of illustration, the user device 106 may be configured to operate in accordance with any of a number of first, second, third, and/or fourth-generation communication protocols and/or the like. For example, the user device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The user device 106 may also be configured to operate in accordance with non-cellular communication mechanisms, such as via a wireless local area network (WLAN) or other communication/data networks.

As described above, the user device 106 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the user device 106 to receive data from a user such as the user 110, may include any of a number of devices allowing the user device 106 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The user device 106 may also include a positioning system device 475 that is configured to be used by a positioning system to determine a location of the user device 106. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the user device 106. In other embodiments, the positioning system device 475 includes a proximity sensor or transmitter, such as an RFID tag, that can sense or be sensed by devices known to be located proximate a merchant or other location to determine that the user device 106 is located proximate these known devices.

The user device 106 further includes a power source 415, such as a battery, for powering various circuits and other devices that are used to operate the user device 106. Embodiments of the user device 106 may also include a clock or other timer 450 configured to determine and, in some cases, communicate actual or relative time to the processor 410 or one or more other devices.

The user device 106 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the user device 106 and/or one or more of the process/method steps described herein. For example, the memory 420 may include such applications as a conventional web browser application 422, or a user application 421, a digital wallet application 424, (or any other application provided by the managing entity system 200). These applications also typically instructions to a graphical user interface (GUI) on the display 430 that allows the user 110 to interact with the user device 106, the managing entity system 200, and/or other devices or systems. In one embodiment of the invention, when the user 110 decides to enroll in a user application 421 program, the user 110 downloads, is assigned, or otherwise obtains the user application 421 from the managing entity system 200, or from a distinct application server (e.g., from the resource account management platform 104). In other embodiments of the invention, the user 110 interacts with the managing entity system 200 or the resource account management platform 104 via the web browser application 422 in addition to, or instead of, the user application 421. The same mechanisms may be put in place to install, store, or otherwise access the digital wallet application 424. The memory 420 of the user device 106 may comprise a Short Message Service (SMS) application 423 configured to send, receive, and store data, information, communications, alerts, and the like via a wireless telephone network.

The user application 421 may comprise an application stored in the memory 420 that is configured to control and/or communicate with a digital wallet 424 of the mobile device system 400 to receive and store resource information or resource account information (e.g., account balances, resource amounts, resource types, wallet addresses public keys, private keys, or the like) from other devices described herein. The user application 421 may also be configured to communicate information received from the digital wallet application 424, the web browser application 422, and/or the SMS application 423. In some embodiments, the user application 421 may be configured to receive instructions from a separate system and cause one or more components of the user device 106 to perform one or more actions. For example, the user application 421 may be configured to receive instructions for erasing certain information from an intelligent resource instrument and writing new information on that instrument. The user application 421 may then cause the near field communication (NFC) chip 495 to erase the certain information from an intelligent resource instrument that is within an interaction distance of the NFC chip 495 and then write the new information onto the intelligent resource instrument.

The digital wallet 424 of the user device 106 may comprise an application created by and/or managed by a financial institution that is configured to securely store financial information, resource account information, user configuration information, billing information, shipping information, authentication information, dynamic resource value information (e.g., dynamic card image or video information), or the like. The digital wallet 424 may be configured to receive account or card information (e.g., credit card information, account information, currency information, blockchain information, or the like) from that has been extracted from an intelligent resource instrument or one or more systems and automatically populate fields within the digital wallet application 424 with the extracted information. For example, the extracted information may be formatted such that the information type and the information field is known and by the digital wallet 424 and can therefore be matched to an applicable field of the digital wallet 424.

The digital wallet 424 may additionally be configured to initiate or otherwise communicate information as part of a transaction request. For example, the user 110 may use the user device 106 to initiate a transaction by tapping or otherwise positioning the NFC chip 495 of the user device 106 within an interaction distance from a point of sale device comprising an card reader device (e.g., the card reader device system 130). This interaction may prompt the digital wallet application 424 to provide transaction information (e.g., credit card information, user name, billing information, wallet address, transaction identification information, authorization information, blockchain information, private key, public key, or the like), and the digital wallet application 424 may then transmit the transaction information to the point of sale device for the purpose of conducting and/or authenticating the requested transaction.

The memory 420 can also store any of a number of pieces of information, and data, used by the user device 106 and the applications and devices that make up the user device 106 or are in communication with the user device 106 to implement the functions of the user device 106 and/or the other systems described herein. For example, the memory 420 may include such data as transaction history data, positional data of the user device 106, and the like.

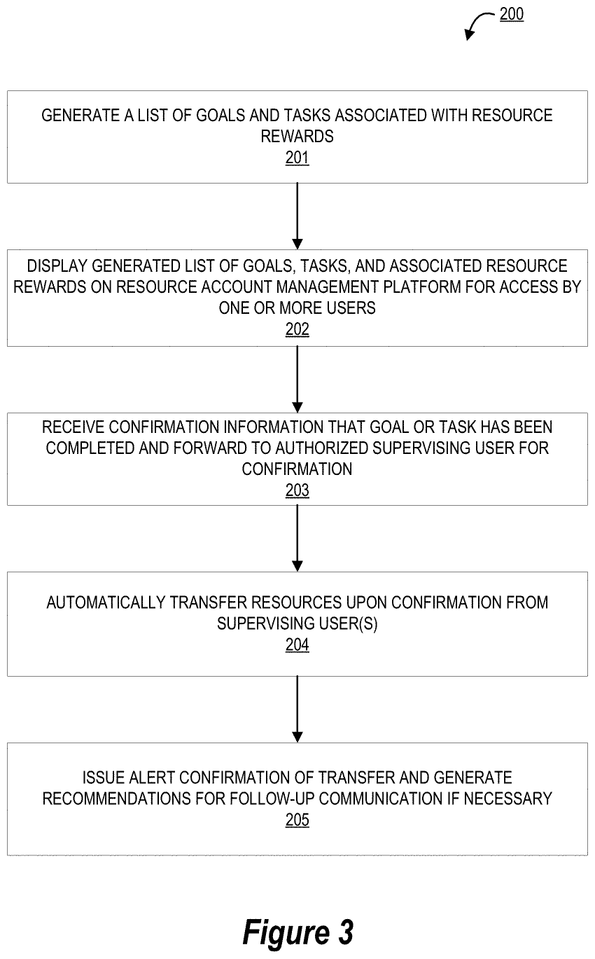

FIG. 3 illustrates a process flow 200 for a goal-oriented resource reward process, in accordance with one embodiment of the present disclosure. The process begins at block 201, where the system generates a list of goals or tasks associated with resource rewards. In some embodiments, the generated list is managed by one or more authorized users such that it may be visible supervised users who may have resource accounts linked to the one or more users resource accounts. For instance, a parent may generate a list of goals using the resource account management platform, and may set a reward amount for resources guaranteed to be paid if the tasks or goals are completed by their children or other supervised users. As shown in block 202, by accessing the resource account management platform, all users in the family may access a display of a centralized list of goals and tasks that are managed and edited by supervising users, such as parents, care takers, older siblings, and the like. The supervising user may access the centralized hub via an application provided by the entity, such as a mobile application, or through a web browser on any number of devices, smart hubs, IoT devices, and the like. The system may require the user submit one or more authenticated credentials in order to be authorized to access the list of goals and tasks and modify the rewards associated with them. In some embodiments, adding or subtracting tasks and goals may require dual authorization from two or more users, (e.g., in the case of a two parent household, two or more supervising users requiring authorization from both, or the like).

In some embodiments, the relationship of the supervising user and the supervised user may not be familial, but instead job or employment based. For instance, the supervising user may be a business manager who maintains and manages one or more accounts for supervised users (employees, staff members, or the like). In some embodiments, the goals or tasks shown in the resource account management tool may be related to job or employment milestones, tasks, assignments or the like which the supervised user may choose to complete in order to receive a motivation or reward, in the form of resources or the like.

As shown in block 203, the system may receive confirmation information that one of the goals or tasks from the centralized list has been completed. This confirmation information may take a number of different forms. For instance, in some embodiments, a supervised user may take a photograph of a completed chore and upload the photograph to the resource account management platform, where it will be disseminated to one or more supervising users. In some embodiments, the photo may be linked to an existing task or goal in the centralized list, and certain textual information, such as a message, tagline, and the like may be appended to communicate that the task or goal has been completed. In other embodiments, the task or goal may be automatically tied to device information from an IoT device or other connected smart home device.

For instance, in one embodiment, a task may exist on the centralized list such as “mow the lawn.” The user authorized to add the task to the centralized list may be given the option by the system to select a smart device, such as a network-connected lawn mower, and may set a run-time for the device that would prove a completion of the task. In this instance, the system would be enabled to receive device information and various sensor data from the connected device, such as the lawn mower, in order to receive an indication that the lawn has been successfully mowed based on tracking movement, operation, duration of operation, or any other sensory information recorded by the connected device. In addition, the user who has completed the task may still be required to append additional information to indicate that the task has been completed. For instance, the supervising or authorized user who created the task may choose to require operation of the lawn mower and a photo of a freshly cut lawn as confirmation information for that particular task.

As shown in block 203, the supervising user must confirm completion of the task or goal based on the received confirmation information before the process 200 proceeds. Upon confirmation, the process proceeds to block 204, where the resource amount associated with the task is transferred to the resource account of the user who has completed the task or goal. In other embodiments, the response to confirming that the task or goal has been completed may differ. For instance, the user responsible for completing the task may unlock a certain amount of resources for spending, may unlock a new spending category, may receive permission to spend resources at a specific event or on a specific product, and the like. As shown in block 205, the users may configure the system to generate and issue an alert that the transfer has been completed. Depending on the resource amount transferred or programmed response to the completed task, the system may also generate information for the parent or supervising user that includes talking points for follow up communication about the completed task or associated reward. For instance, if the user who completed the task receives an amount of resources that allows that user to reach a certain spending goal, the system may recognize this and prompt the parent of the user with talking points about responsible spending habits, avenues for investment and savings, and the like that may affect the child's decision to make a certain purchase, may allow them to make a more informed decision, or may allow the parent to capitalize on an opportunity for an educational financial discussion.

As stated, in some embodiments, the relationship of the supervising user and the supervised user may not be familial, but instead job or employment based. For instance, the supervising user may be a business manager who maintains and manages one or more accounts for supervised users (employees, staff members, or the like). In such embodiments, depending on the resource transfer or programmed response to the completed task or goal, the system may also generate information for the supervising user that includes talking points for follow up communication about the completed task or associated reward which is tailored to the specific embodiment of employer/employee. For instance, the resource account management system may transmit a message to the supervising user that a an employee has completed a certain task or milestone, and may recommend a follow up review of the employees work, progress, or future potential for additional goals or tasks.

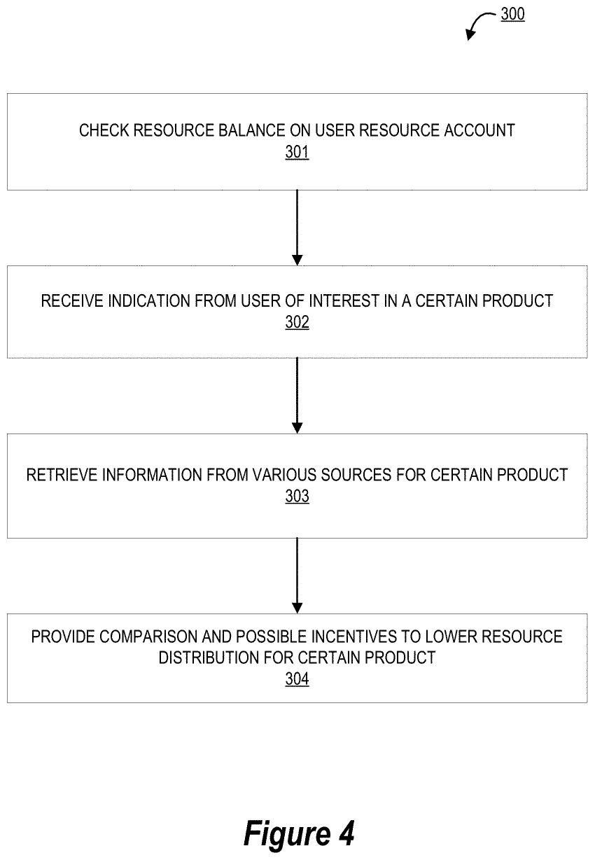

FIG. 4 illustrates a process flow 300 for price comparison of goal products, in accordance with one embodiment of the present disclosure. In some embodiments, a user of a resource account, such a supervised user, may be interested in saving toward the purchase of a certain product. As shown in block 301, the system may check the resource balance on a supervised resource account, and use this in conjunction with a received indication (i.e. via a user device, wearable device, IoT device, smart home device, and the like) in order to determine and present relevant pricing information for the certain product that may be helpful in establishing a specific goal (e.g., the system may determine a difference between available savings in a supervised resource account and the price of an item, and display “you are X dollars from being able to purchase X product!” or the like). In addition to establishing the goal savings amount, the system may calculate an estimated amount of time needed to save for the certain product based on history of the supervised user's earnings, resource transfers and deposits, spending habits, and available tasks that may increase earning potential. For instance, the system may divide the difference in savings amount and goal product price by the weekly allowance of the supervised user, and display a message indicating the amount of weeks it would take to save for the goal product at the given rate.

The system may proactively recommend certain steps that the supervised user may take in order to reach the goal more quickly, and may transmit and display information via a graphical interface to the supervised user of the estimated amount of time that the user may expect to wait in order to reach the goal in certain instances. The supervised user may interact with the system in order to simulate scenarios in which the user earns more resources by completing certain tasks in order to create a plan of action to reach the goal more quickly. For example, the system may access an available chore or task list created by a supervising user and display available opportunities for earning additional resources to the supervised user. The system may intelligently select certain chores or tasks based on value, time period, previous successful completion, or the like, in order to display a detailed suggested plan of action to the supervised user. For instance, the system may display “try walking the dog 4 times, mowing the lawn, and taking out the trash this week to reach your goal X amount of days earlier!”

As shown in block 303, the system may also access pricing information from external sources, such as various online merchants, nearby stores, and the like in order to provide a price comparison, as shown in block 304. These price comparisons act to educate the supervised user that price shopping and comparison can be a beneficial resource management and budgeting tool. Additionally, the system may retrieve historical price fluctuations over time and display this information to the supervised user in a simplified format in order to illustrate to the supervised user that waiting for the item to go on sale or waiting for a reduced price during a specific time of year, such as holiday sales, and the like, may allow the supervised user to save money on the purchase price of a goal product by timing their purchase advantageously.

Additionally, in some embodiments, the entity may have access to additional motivations, such as “cash back” motivations, rebates, coupons, group coupons, and the like that may save the supervised user additional resources for a particular product or service. In some embodiments, the motivations may not be specifically related to the certain goal product that the supervised user is interested in purchasing, but instead may be an additional or alternative product or service that the supervised user may be eligible to receive if the supervised user saves a certain amount of resources. For instance, if the supervised user is able to save a certain dollar amount in resources without spending for a certain period of time, the system may offer a celebration motivations, such as a free meal at a nearby restaurant location or the like in order to teach the user that saving resources can be a positive, rewarding experience that calls for celebration.

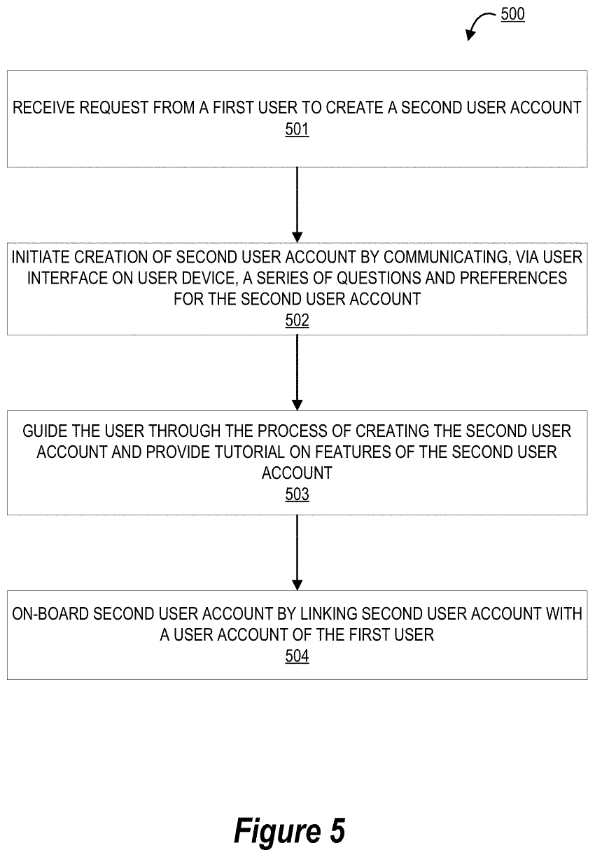

FIG. 5 illustrates a process flow 500 for guided creation of a new user resource account, in accordance with one embodiment of the present disclosure. In some embodiments, a supervising user, such as a parent, may be interested in creating a resource account for a supervised user. Depending on the supervised user's number of years of life, the supervising user's preferences with regard to the supervised user's autonomy in managing resources, or the like, the system may intelligently recommend certain services and educational modules to effectively onboard the supervised user with a newly created resource account that is linked to and at least partially managed by the supervising user's account. The process begins at bock 501, where the system may receive a request from the supervising user to create a supervised user resource account, otherwise referred to as “onboarding” the supervised user to the resource management platform. The system then initiates the creation of the supervised user resource account by communicating, via a user interface on a user device, a series of questions and preference options to gain a more detailed description of the supervised user, as shown in block 502. Depending on the supervised user's years of life, the supervised user may be eligible for a range of autonomy with regard to how the account is managed. For instance, a certain group of users under 11 years of life may only be able to view their resource account, while a user in the range of 12-17 years may be eligible to access resources, transfer resources, and spend resources on their own. It is understood that these ranges may vary, and are provided only as examples that the delineation between user permissions may be altered based on the specific supervised user. It is understood that the level of autonomy based on the supervised user may differ based on settings programmed by the supervising user, may be influenced by the law in a particular geographic area or jurisdiction, or both, and that the system may be intelligently designed to identify these restrictions and present them to the supervising user accordingly as suggestions or requirements depending on the scenario. In some embodiments, the system may crowd-source anonymized data regarding the management of supervised user accounts and provide peer insights on the level of interaction typically allowed for certain groups of supervised users, and potential benefits of introducing certain concepts at given milestones, again enhancing the ability for the supervising user to utilize the system to capitalize on potential educational opportunities.

As shown in block 503, the system may guide the supervising user in the creation of the supervised user's resource account, providing a tutorial to both the supervising and supervised user (e.g., the tutorial may differ in language and complexity for the supervised user and the supervising user) with regard to how the supervised user's resource account will operate and may be managed. The tutorial provided may be bifurcated such that the supervising user receives a more complex and detailed description of user preferences, permissions, and account management principles, while the supervised user simply receives an introduction to resource accounts, and their permitted activities and interactions with the account in general. Finally, as shown in block 504, the system may onboard the supervised user by creating and linking the supervised user's resource account with a resource account of the supervised user, such that the accounts may interface with one another and provide the other services and features described throughout the present disclosure.

In some embodiments, the supervised user's resource account may be transitioned as the supervised user grows older, such that the account is automatically converted or upgraded over time as the user reaches a new bracket in terms of years of life. For instance, a supervised user that has been onboarded at 8 years may receive additional permissions at 11 years, and again at 18 years, at which point the user may be given the option to de-link their account from the supervising user's account management and maintain full control over their available resources and spending habits as a legal adult. In some embodiments, the entity managing the resource account management platform may offer special interest rates, services, or products to the supervised user when the reach legal adulthood based on their history of completing certain educational modules, participation in onboarding their account when they were younger, or the like.

In some embodiments, the supervised user may be issued a payment instrument associated with their resource account, such as their own personal debit card. While the supervised user's debit card may appear to be a fully operational and conventional debit card, it may have certain restrictions placed on it by the supervising user as dictated in the supervising user's preferences and permissions set from the resource management platform. For instance, the supervised user's debit card may be associated with a pin code that only works at certain times of day, or at certain locations in order to authorize payment. In other embodiments, the supervised user's debit card may only be operational with ATM locations owned by the issuing entity, and may only provide access to certain denominations of resources per period of time. For instance, the supervised user may only be able to withdraw increments of five or ten dollars at a time. In other embodiments, the supervising user may set a withdrawal limit, geofence limit for authorized spending, limited spending categories, or one-time use authorizations to use the payment instrument at a certain time or place. As the supervised user grows older, the ability for the supervising user to place restrictions on the supervised user's payment instrument may decrease, or be deactivated completely if the supervised user reaches adulthood.

Each communication interface described herein generally includes hardware, and, in some instances, software, that enables the computer system, to transport, send, receive, and/or otherwise communicate information to and/or from the communication interface of one or more other systems on the network. For example, the communication interface of the user input system may include a wireless transceiver, modem, server, electrical connection, and/or other electronic device that operatively connects the user input system to another system. The wireless transceiver may include a radio circuit to enable wireless transmission and reception of information.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for intelligent onboarding and resource account management, the system comprising:
at least one memory device with computer-readable program code stored thereon;
at least one communication device;
at least one processing device operatively coupled to the at least one memory device and the at least one communication device, wherein executing the computer-readable program code is configured to cause the at least one processing device to:
receive, from a user device, a request to access the resource account management platform;
display to a user, via a graphical interface of the resource account management platform, a resource account summary and resource account management selections, wherein the resource account management selections comprise an option to onboard a second user;
receive a selection to onboard the second user to the resource account management platform; and
onboard the second user by automatically creating a resource account for the second user and linking the resource account for the second user with a resource account of the user by authorizing resource transfers from the resource account of the user and the resource account of the second user.

2. The system of claim 1, further comprising:
generating a list of goals and tasks for display via the resource account management platform;
displaying to the second user, via the graphical interface of the resource account management platform, the list of goals and tasks;
receive an indication from the user device that the second user has completed one or more goals or tasks from the list of goals and tasks;
automatically initiate a transfer of a predetermined resource amount from the resource account of the user to the resource account of the second user; and
transmit an alert via the graphical interface of the resource account management platform to the user.

3. The system of claim 2, wherein the alert further comprises recommendations for follow-up communication and discussion of resource management decisions and practices.

4. The system of claim 2, wherein the goals or tasks are created by the user via the resource account management platform and displayed to the second user automatically, and wherein the goals or tasks comprise a qualitative summary of necessary conditions for completion and quantitative resource amount associated with completion.

5. The system of claim 1, further comprising:
continuously monitoring a resource balance of the second user's resource account;
receiving an indication via the resource account management platform that the second user has identified a goal product or service;
retrieve a resource amount for the goal product or service from an external information source;
identify one or more goals or tasks and associated resource reward amounts; and
transmit a summary comparison of the resource amount for the goal product and the associated resource reward amounts of the one or more goals or tasks via the graphical interface of the resource account management platform.

6. The system of claim 5, wherein the summary comparison is continuously updated based on the second user's completion of the one or more goals or tasks.

7. The system of claim 1, wherein onboarding the second user further comprises:
transmitting a series of questions to the user via the graphical interface of the resource account management platform, and wherein subsequent questions may be dynamically altered based on the user's answer to previous questions;
providing, via the graphical interface of the resource account management platform, one or more recommendations for restrictions of the resource account of the second user;
receiving a selection of one or more restrictions of the resource account of the second user; and
automatically implementing selected restrictions for the resource account of the second user.

8. A computer program product for intelligent onboarding and resource account management, the computer program product comprising a non-transitory computer-readable storage medium having computer-executable instructions to:
receive, from a user device, a request to access the resource account management platform;
display to a user, via a graphical interface of the resource account management platform, a resource account summary and resource account management selections, wherein the resource account management selections comprise an option to onboard a second user;
receive a selection to onboard the second user to the resource account management platform; and
onboard the second user by automatically creating a resource account for the second user and linking the resource account for the second user with a resource account of the user by authorizing resource transfers from the resource account of the user and the resource account of the second user.

9. The computer program product of claim 8, further comprising:
generating a list of goals and tasks for display via the resource account management platform;
displaying to the second user, via the graphical interface of the resource account management platform, the list of goals and tasks;
receive an indication from the user device that the second user has completed one or more goals or tasks from the list of goals and tasks;
automatically initiate a transfer of a predetermined resource amount from the resource account of the user to the resource account of the second user; and
transmit an alert via the graphical interface of the resource account management platform to the user.

10. The computer program product of claim 9, wherein the alert further comprises recommendations for follow-up communication and discussion of resource management decisions and practices.

11. The computer program product of claim 9, wherein the goals or tasks are created by the user via the resource account management platform and displayed to the second user automatically, and wherein the goals or tasks comprise a qualitative summary of necessary conditions for completion and quantitative resource amount associated with completion.

12. The computer program product of claim 8, further comprising:
continuously monitoring a resource balance of the second user's resource account;
receiving an indication via the resource account management platform that the second user has identified a goal product or service;
retrieve a resource amount for the goal product or service from an external information source;
identify one or more goals or tasks and associated resource reward amounts; and
transmit a summary comparison of the resource amount for the goal product and the associated resource reward amounts of the one or more goals or tasks via the graphical interface of the resource account management platform.

13. The computer program product of claim 10, wherein the summary comparison is continuously updated based on the second user's completion of one or more goals or tasks.

14. The computer program product of claim 8, wherein onboarding the second user further comprises:
transmitting a series of questions to the user via the graphical interface of the resource account management platform, and wherein subsequent questions may be dynamically altered based on the user's answer to previous questions;
providing, via the graphical interface of the resource account management platform, one or more recommendations for restrictions of the resource account of the second user;
receiving a selection of one or more restrictions of the resource account of the second user; and
automatically implementing selected restrictions for the resource account of the second user.

15. A computer implemented method for intelligent onboarding and resource account management, the computer implemented method comprising:
receiving, from a user device, a request to access the resource account management platform;
displaying to a user, via a graphical interface of the resource account management platform, a resource account summary and resource account management selections, wherein the resource account management selections comprise an option to onboard a second user;
receiving a selection to onboard the second user to the resource account management platform; and
onboarding the second user by automatically creating a resource account for the second user and linking the resource account for the second user with a resource account of the user by authorizing resource transfers from the resource account of the user and the resource account of the second user.

16. The computer implemented method of claim 15, further comprising:
generating a list of goals and tasks for display via the resource account management platform;
displaying to the second user, via the graphical interface of the resource account management platform, the list of goals and tasks;
receive an indication from the user device that the second user has completed one or more goals or tasks from the list of goals and tasks;
automatically initiate a transfer of a predetermined resource amount from the resource account of the user to the resource account of the second user; and
transmit an alert via the graphical interface of the resource account management platform to the user.

17. The computer implemented method of claim 16, wherein the alert further comprises recommendations for follow-up communication and discussion of resource management decisions and practices.

18. The computer implemented method of claim 16, wherein the goals or tasks are created by the user via the resource account management platform and displayed to the second user automatically, and wherein the goals or tasks comprise a qualitative summary of necessary conditions for completion and quantitative resource amount associated with completion.

19. The computer implemented method of claim 15, further comprising:
continuously monitoring a resource balance of the second user's resource account;
receiving an indication via the resource account management platform that the second user has identified a goal product or service;
retrieve a resource amount for the goal product or service from an external information source;
identify one or more goals or tasks and associated resource reward amounts; and
transmit a summary comparison of the resource amount for the goal product and the associated resource reward amounts of the one or more goals or tasks via the graphical interface of the resource account management platform.

20. The computer implemented method of claim 19, wherein the summary comparison is continuously updated based on the second user's completion of the one or more goals or tasks.
